(19) United States
(12) Patent Application Publication
(10) Pub. No.: US 2007/0296238 A1
(43) Pub. Date: Dec. 27, 2007

(54) Front Structure of Vehicle

(76) Inventors: Yuuji Kinoshita, Tokyo (JP); Teruyuki Taura, Tokyo (JP); Takeshi Akagawa, Tokyo (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/769,267

(22) Filed: Jun. 27, 2007

(30) Foreign Application Priority Data
Jun. 27, 2006 (JP) 2006-175965

(51) Int. Cl. B60J 10/02

(52) U.S. Cl. 296/93

(57) ABSTRACT

It is an object of the present invention to prevent deterioration of the appearance of a front pillar when a side door is open, thanks to surely covering the gap with a hollow-shape portion even if a gap between a molding and the front pillar is changed hollow-shape portion.

A front pillar (17) is provided between a side portion of a windshield glass (13) and a front portion of a side door (14), and a molding (27) is fitted into an outer periphery portion of the windshield glass (13). Also, the inner surface of the side portion of the windshield glass (13) is bonded to the front pillar (17), and a hollow-shape portion (28d) to be brought into contact with the front pillar (17) is provided at the molding (27). Moreover, the hollow-shape portion (28d) is constructed to be brought into contact with the front pillar (17) so as to cover the gap between the molding (27) and the front pillar (17).

### BACKGROUND OF THE INVENTION

1. Field of the Invention

The present invention relates to a structure of a front corner portion in which a front pillar is provided between a windshield glass side portion and a side door front portion in a vehicle such as a truck, a passenger car, a bus and the like.

2. Description of the Related Art

In the prior art, there has been disclosed a front structure of a vehicle in which a front corner member extending along a side portion of a windshield glass and a front portion of a side glass is provided between the side portion of the windshield glass and the front portion of the side glass and the width of the front corner member is 40 to 58 mm when viewed by a driver seated in a driver's seat of the vehicle (for example, refer to patent Document 1). In this front structure of a vehicle, the front corner member comprises a front pillar, a door frame, a glass frame and a glass run, and the front pillar is formed in a cylindrical shape by bonding both side portions of a pillar inner panel and both side portions of a pillar outer panel. The pillar inner panel has a pillar inner body provided along the visual line direction of a driver seated in a driver's seat of a truck, a first front flange formed integrally with the pillar inner body at the front portion of the pillar inner body, and a first rear flange formed integrally with the pillar inner body at the rear portion of the pillar inner body. Also, the pillar outer panel has a pillar outer body provided substantially opposite to the front face of the door frame, a second front flange formed integrally with the pillar outer body at the front portion of the pillar outer body, and a second rear flange formed integrally with the pillar outer body at the rear portion of the pillar outer body. A front overlap portion is formed by bonding the pillar outer surface of the first front flange and the pillar inner surface of the second front flange. Also, an adhesive is filled in a gap between the front overlap portion and the inner surface of the windshield glass, and the side portion of the windshield glass is mounted to the front pillar by using this adhesive. Moreover, a molding is fitted into the outer periphery portion of the glass in order to improve appearance of the outer periphery portion of the windshield glass.

In the front structure of a vehicle constructed as above, the width of the front corner member is 40 to 58 mm when viewed from a driver seated in a driver's seat of the vehicle. Therefore, when the driver of the vehicle focuses his both eyes to a target outside diagonally right in front of the vehicle in order to turn right at an intersection, for example, the relatively narrow front corner member close to him looks blurred due to parallax, and the target beyond the front corner member is not obstructed by the front corner member and thereby the driver can see a continuous visual field from the front of the vehicle to the right side. As a result, the driver of the vehicle does not have to move his upper body right or left in order to visually check the target beyond the front corner member and thereby the driver can surely check the target outside the vehicle visually only by looking straight in the direction of the front corner member by moving only his head.

Patent Document 1

Japanese Unexamined Patent Application Publication No. 2006-96270 (claim 1, paragraphs [0007], [0008], [0011] to ([0013])

However, in the front structure of a vehicle shown in the above prior-art Patent Document 1, there has been a problem that a gap is generated between the glass and the vehicle body when a windshield glass is assembled to a vehicle body unevenly in the right and left direction, which impairs the appearance and causes leakage of an adhesive. Specifically, in case of the right front pillar, if the windshield glass is assembled to the front pillar in a direction where the side portion of the windshield glass is separated from the front pillar, that is, in a state where it is displaced to the right side in the vehicle width direction, there is generated a gap between the molding fitted into the side portion of the windshield glass and the front pillar, which might impair the appearance of the front pillar when a side door is open, while if the windshield glass is assembled to the front pillar in a direction where the side portion of the windshield glass gets close to the front pillar, that is, in a state where it is displaced to the left side in the vehicle width direction, the molding fitted into the side portion of the windshield glass interferes with the front pillar and it is lifted up to the front, which impairs the appearance of the side portion of the windshield glass.

### SUMMARY OF THE INVENTION

A first object of the present invention is to provide a front structure of a vehicle which can prevent lowering of the appearance of a front pillar when a side door is open, thanks to surely covering the gap with a hollow-shape portion even if a gap between a molding and the front pillar is changed hollow-shape portion.

A second object of the present invention is to provide a front structure of a vehicle which can prevent lowering of an appearance of a windshield glass by covering a gap between a molding and a front pillar with a hollow-shape portion while a seal pressure is kept even so that the windshield glass is not lifted to the front even if the gap is changed.

A third object of the present invention is to provide a front structure of a vehicle which can prevent lowering of the appearance of both side portions of a windshield glass, thanks to covering a gap between a molding and a front pillar by deformation of a hollow-shape portion even if assembling of the windshield glass is displaced with respect to the front pillar in the vehicle width direction.

An invention of claim 1 is improvement of a front structure of a vehicle, as shown in FIGS. 1 to 3, in which a front pillar 17 is provided between a side portion of a windshield glass 13 and a front portion of a side door 14, a molding 27 is fitted into an outer periphery portion of the windshield glass 13, and the inner surface of the side portion of the windshield glass 13 is bonded to the front pillar 17.

Its characteristic construction is that a hollow-shape portion 28d to be brought into contact with the front pillar 17 is provided at the molding 27, and the hollow-shape portion 28d is constructed to be brought into contact with the front pillar 17 so as to cover a gap between the molding 27 and the front pillar 17.

In the front structure of a vehicle described in claim 1, when assembling of the windshield glass 13 with respect to the front pillar 17 is displaced, a positional relation of the molding 27 with respect to the front pillar 17 is changed, but a gap between the molding 27 and the front pillar 17 is surely covered by the hollow-shape portion 28d, and a change of this gap is absorbed by deformation of the hollow-shape portion 28d. Also, since the hollow-shape portion 28d surely covers the gap between the molding 27 and the front pillar 17 while a seal pressure is kept even, there is generated little force that the hollow-shape portion 28d lifts up the windshield glass 13.

An invention of claim 2 is related to claim 1, wherein the front pillar 17 is covered with the windshield glass 13 as shown further in FIGS. 1 to 3.

In the front structure of a vehicle described in claim 2, since the front pillar 17 is covered with the windshield 13, even if assembling of the windshield glass 13 with respect to the front pillar 17 is displaced in the vehicle width direction, the gap between the molding 27 and the front pillar 17 is surely covered by deformation of the hollow-shape portion 28d.

According to the present invention, the hollow-shape portion to be brought into contact with the front pillar is provided at the molding and the hollow-shape portion is constructed to be brought into contact with the front pillar so as to cover the gap between the molding and the front pillar. Therefore, even if assembling of the windshield glass with respect to the front pillar is displaced and a positional relation of the molding with respect to the front pillar is changed, the gap between the molding and the front pillar is surely covered by the hollow-shape portion and a change of this gap is absorbed by deformation of the hollow-shape portion. As a result, the appearance of the front pillar when the side door is open is not impaired. Also, since the hollow-shape portion surely covers the gap between the molding and the front pillar while the seal pressure is kept even, there is generated little force that the hollow-shape portion 28d lifts up the windshield glass 13. As a result, even if the gap is changed, the windshield glass is not lifted to the front, and the appearance of the windshield glass is not impaired.

Moreover, even if assembling of the windshield glass to the front pillar is displaced in the vehicle width direction, covering the front pillar with the windshield glass can surely cover, a gap between the molding and the front pillar by deformation of the hollow-shape portion. As a result, the hollow-shape portion surely covers the gap, even if the windshield glass is displaced in the vehicle width direction, and the appearance of the both side portions of the windshield glass is not impaired.

### BRIEF DESCRIPTION OF THE DRAWINGS

FIG. 1 is an A-A sectional view of FIG. 6 illustrating a front structure of a vehicle of an embodiment of the present invention;

FIG. 2 is a sectional view corresponding to FIG. 1, illustrating a state where a windshield glass is assembled to a front pillar in displacement to the left side in the vehicle width direction;

FIG. 3 is a sectional view corresponding to FIG. 1, illustrating a state where the windshield glass is assembled to the front pillar in displacement to the right side in the vehicle width direction;

FIG. 4 is a sectional view of an essential part illustrating a state immediately before a side molding is fitted into the side portion of the windshield glass;

FIG. 5 is an exploded perspective view of an essential part including the front pillar, the molding and the windshield glass; and

FIG. 6 is a perspective view of an essential part of a truck including a. side door, the molding and the windshield glass.

### DETAILED DESCRIPTION OF THE PREFERRED EMBODIMENTS

Preferred embodiments according to the present invention will be described below based on the attached drawings.

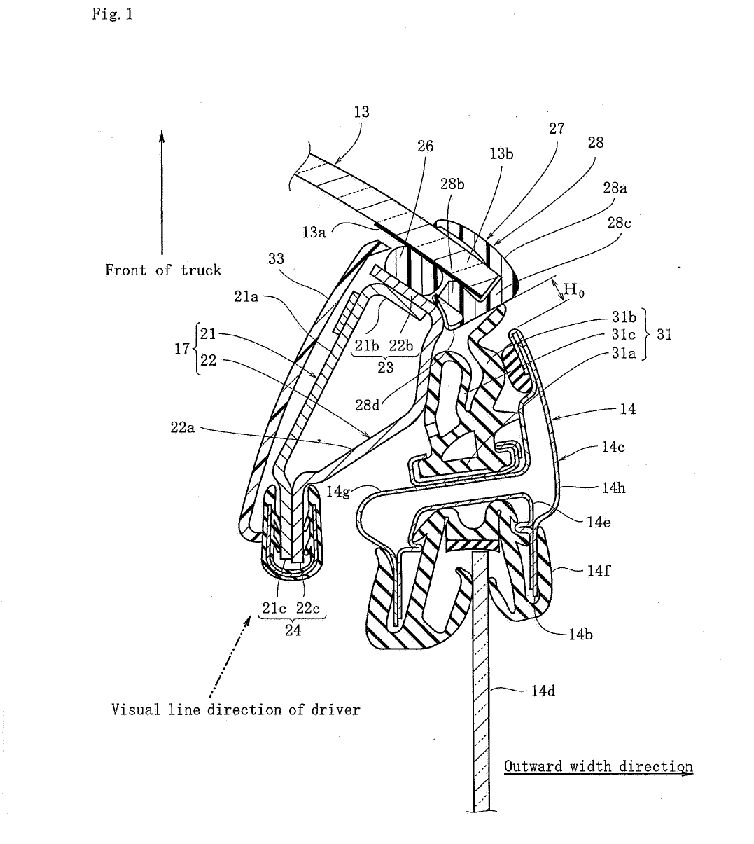

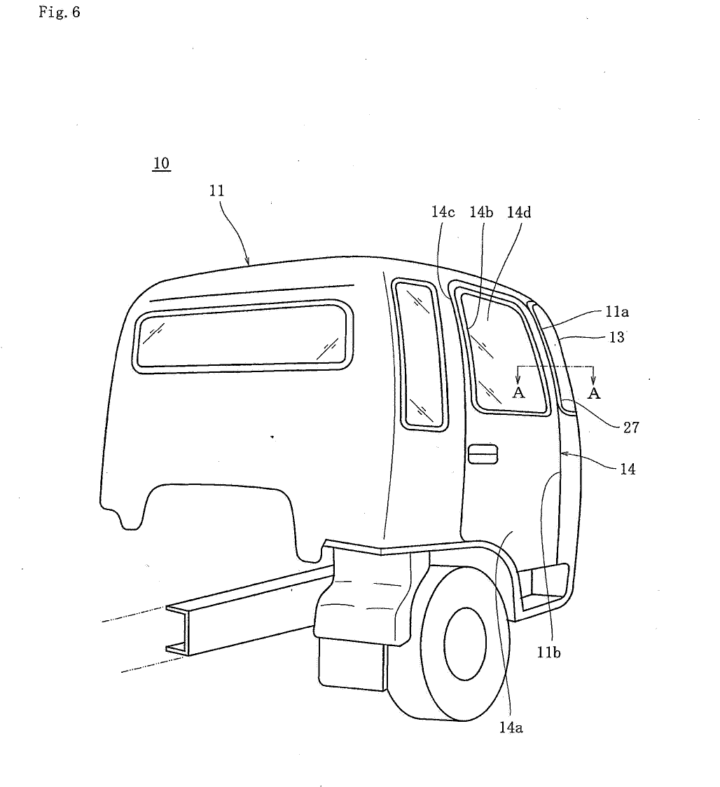

As shown in FIG. 6, a driver's seat in which a driver is seated is provided on the right side of a cab 11 of a truck 10, and a front opening 11a on the front face of the cab 11 is closed by a transparent windshield glass 13. Also, a side opening 11b through which the driver gets on/off the vehicle is provided on the side face on the driver's seat side of the cab 11, and this side opening 11b is closed by a side door 14, capable of being kept open (FIGS. 1 to 3 and 6). Between the side portion of the windshield glass 13 and the front portion of the side door 14, a front pillar 17 is provided extending along the side portion of the glass 13 and the front portion of the door 14. This front pillar 17 is formed in a cylindrical shape extending substantially in the vertical direction, for example, by bonding both side portions of a pillar inner panel 21 and both side portions of a pillar outer panel 22. Thus, the cross section of the front pillar 17 is formed in a closed section. In this embodiment, the side door and the front pillar on the driver's seat side will be described, but the present invention may be applied to the side door and the front pillar on the passenger seat side. Also, the present invention may be applied to a vehicle such as a truck in which a driver's seat is provided on the left side.

The pillar inner panel 21 comprises a pillar inner body 21a provided along the visual line direction of the driver seated in the driver's seat of the truck 10, a front inner flange 21b formed integrally with the pillar inner body 21a on the front portion of the pillar inner body 21a, and a rear inner flange 21c formed integrally with this pillar inner body 21a on the rear portion of the pillar inner body 21a. The front inner flange 21b is provided inside the cab 11 with a predetermined gap from the inner surface of the windshield glass 13 and extending substantially in parallel with the inner surface of the windshield glass 13 toward the side portion of the windshield glass 13. That is, it is provided extending in the direction approaching to a door frame 14c of the side door 14. Also, the rear inner flange 21c is provided inside the cab 11 with a predetermined gap from the inner surface of the door frame 14c and extending substantially in parallel with the inner surface of the door frame 15c rearward.

The pillar outer panel 22 comprises a pillar outer body 22a provided substantially opposite to the front face of the door frame 14c, a front outer flange 22b formed integrally with this pillar outer body 22a on the front portion of the pillar outer body 22a, and a rear outer flange 22c formed integrally with this pillar outer body 22a on the rear portion of the pillar outer body 22a. The front outer flange 22b is provided inside the cab 11 with a predetermined gap from the inner surface of the windshield glass 13 and extending substantially in parallel with the inner surface of the windshield glass 13 and in the direction opposite to the side portion of the windshield glass 13. That is, it is provided extending in the direction away from the door frame 14c. The rear outer flange 22c is provided inside the cab 11 with a predetermined gap from the inner surface of the door frame 14c and extending substantially in parallel with the inner surface of the door frame 14c rearward.

A front overlap portion 23 is formed by bonding the pillar outer surface of the front inner flange 21b and the pillar inner surface of the front outer flange 22b, and a rear overlap portion 24 is formed by bonding the pillar inner surface of the rear inner flange 21c and the pillar inner surface of the rear outer flange 22c (FIGS. 1 to 3). The front overlap portion 23 is provided along the inner surface of the side portion of the windshield glass 13. Thus, the front pillar 17 is constructed to be covered with the windshield glass 13. Also, a blind film 13a with a predetermined width is formed by ceramic coating on the inner surface of the outer periphery portion of the windshield glass 13, and the inner surface of the side portion of the windshield glass 13 is bonded to the pillar outer surface of the front overlap portion 23 by an adhesive 26 for glass. By this, since the adhesion surface of the windshield glass 13 is made in a double structure of the front inner flange 21b and the front outer flange 22b, rigidity of the adhesion surface of the glass 13 can be improved, and the adhesive 26 for glass and the front pillar 17 can not be visually recognized since they are shielded by the blind film 13a when the truck is seen from the front.

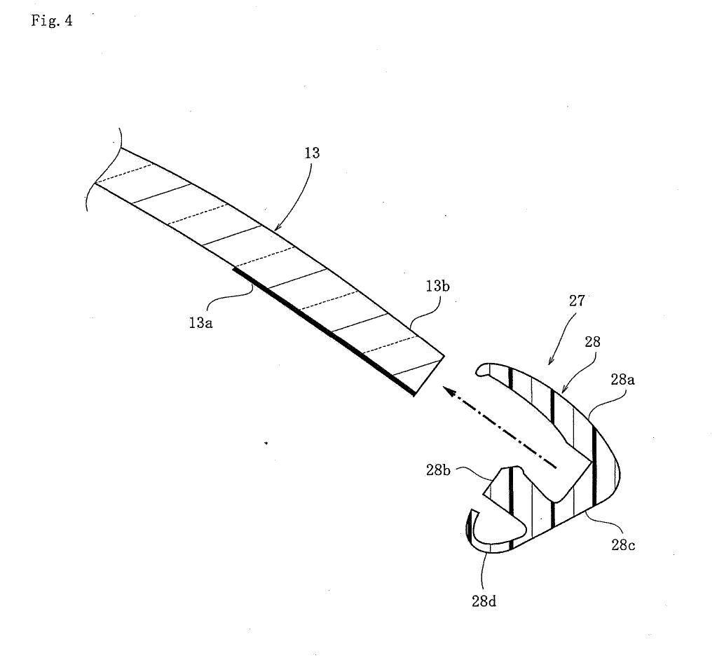

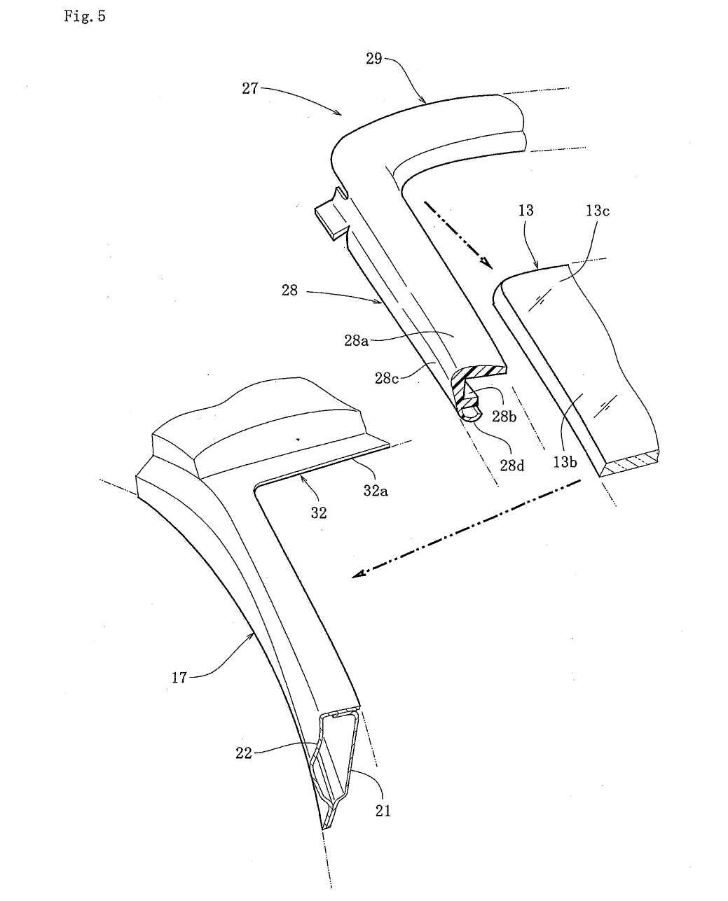

On the outer periphery portion of the windshield glass 13, a molding 27 made of a soft synthetic resin or rubber is fitted so as to improve appearance of the outer periphery portion of this glass 13. As shown in FIGS. 4 and 5, this molding 27 is provided with a side molding 28 fitted into a side portion 13b of the windshield glass 13 and an upper molding 29 fitted into an upper portion 13c of the windshield glass 13. The end of the upper molding 29 (left end in FIG. 5) is connected to and integrated with the upper end of the side molding 28. The side molding 28 comprises a side outer portion 28a covering the outer surface of the side portion 13b of the windshield glass 13, a side inner portion 28b covering the inner surface of the side portion 13b of the windshield glass 13, and a side connecting portion 28c connecting the side outer portion 28a and the side inner portion 28b to each other and covering the end face of the side portion 13b of the windshield glass 13. At the side inner portion 28b, a hollow-shape portion 28d to be brought into contact with the front pillar 17 is provided along the longitudinal direction of the side inner portion 28b. This hollow-shape portion 28d is preferably molded integrally with the molding 27 from the same material as that of the molding 27. Also, it is preferable that the hollow-shape portion 28d is formed with a cross section substantially in the J-shape at the time of molding and constructed so that the cross section is elastically deformed substantially in the flat ring shape when it is brought into contact with the front pillar 17 and is formed with a relatively small thickness of 0.5 to 2 mm, for example. Moreover, when the hollow-shape portion 28d is brought into contact with the front pillar 17, a gap between the side molding 28 and the front pillar 17 is covered. The hollow-shape portion 28d is not limited to the substantial J-shape one but includes a completely hollow one without discontinuity at one end. The completely hollow one does not have turning-up of a lip and the like, and its appearance can be further improved.

On the other hand, the side door 14 comprises a door body 14a, the door frame 14c provided on the upper face of this door body 14a and formed substantially in the inverted U-shape so as to form a door window 14b, and a transparent side glass 14d closing the door window 14b capable of being kept open (FIGS. 1 to 3 and 6). The front portion of the side glass 14d is surrounded by a glass run 14f, and the glass run 14f is attached to a glass frame 14e so as to hold and guide the side glass 14d (FIGS. 1 to 3). Also, the door frame 14c is formed by bonding a door inner panel 14g and a door outer panel 14h. And the glass frame 14e is attached by insertion to the door frame 14c, and between this door frame 14c and the right side portion of the windshield glass 13, the front pillar 17 is provided along the right side portion of the windshield glass 13 and the front portion of the side glass 14d. At the door inner panel 14g, a door weather-strip 31 to be brought into contact with the front pillar 17 and the side molding 28 is provided. This door weather-strip 31 comprises a weather-strip body 31a mounted on the front surface of the door inner panel 14g, a first seal portion 31b provided integrally with this weather-strip body 31a and substantially in the wave-plate shape brought into contact with the side molding 28, and a cylindrical second seal portion 31c provided integrally with the weather-strip body 31a and to be brought into contact with the front pillar 17.

On the other hand, as shown in FIG. 5, the upper end of the front pillar 17 is connected to a roof member 32, while the lower end of the front pillar 17 is connected to a cowl member (not shown). At the front portion of the roof member 32, an upper flange 32a along the upper part of the windshield glass 13 is provided, while at the upper part of the cowl member, a lower flange (not shown) along the lower part of the windshield glass 13 is provided. Reference numeral 33 in FIGS. 1 to 3 denotes a pillar garnish provided along the pillar outer surface of the pillar inner body 21a.

Action of the front structure of the truck 10 constructed as above will be described.

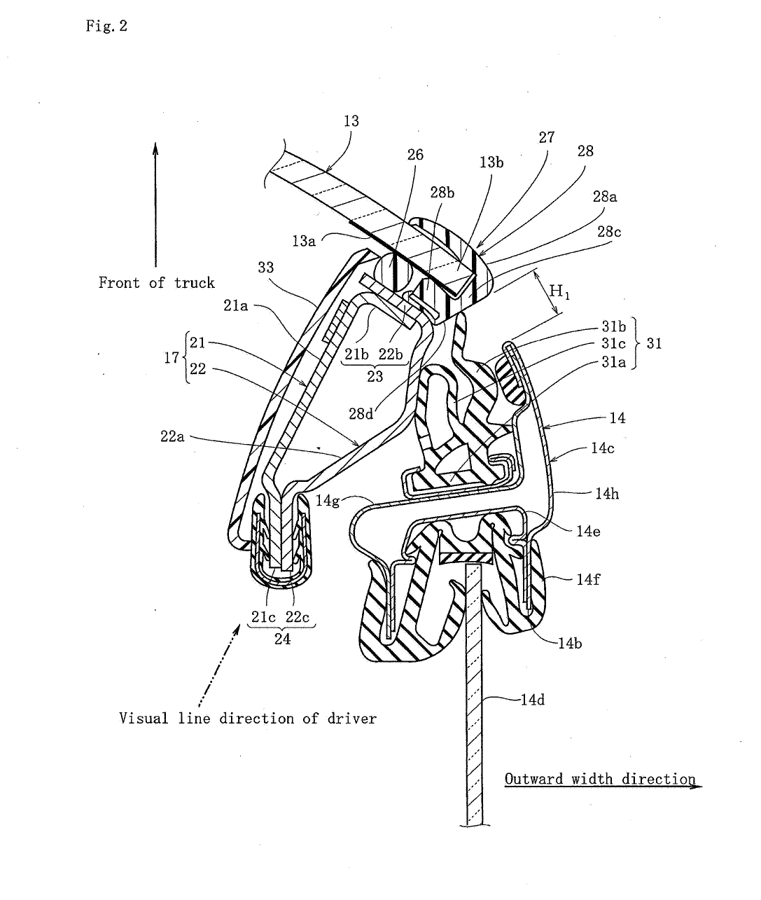

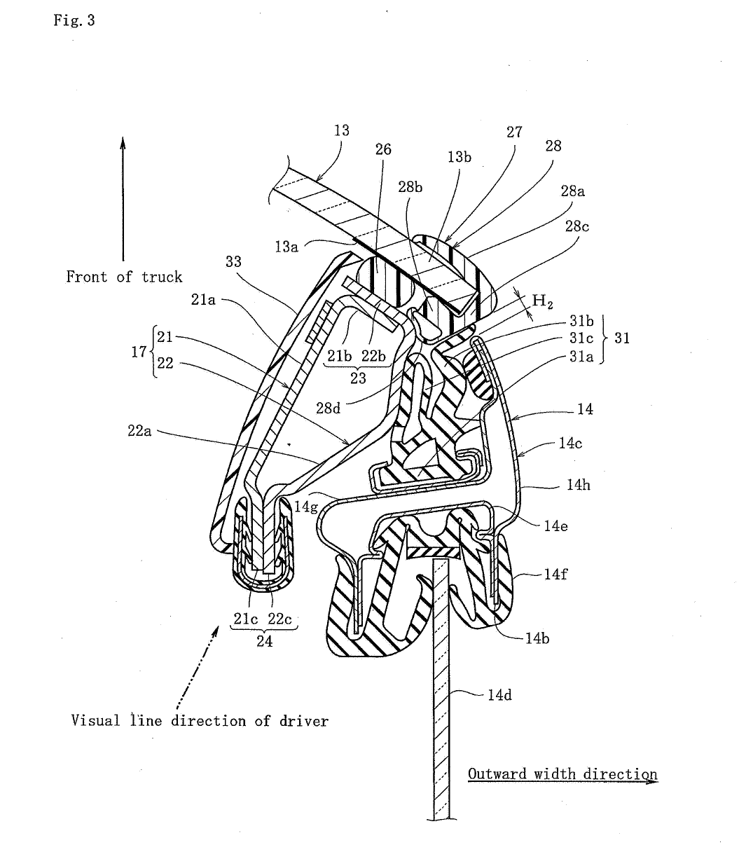

If assembling of the windshield glass 13 with regard to the front pillar 17 is displaced, the positional relation of the molding 27 with respect to the front pillar 17 is changed as shown in FIGS. 1 to 3. Specifically, if the windshield glass 13 is assembled to the front pillar 17 as designed, a gap between the molding 27 and the side door 14 becomes H₀ as shown in FIG. 1. If the windshield glass 13 is displaced in the left direction in FIG. 2 with respect to the front pillar 17, the gap between the molding 27 and the side door 14 is widened to H₁ as shown in FIG. 2, while the windshield glass 13 is displaced in the right direction in FIG. 3 with respect to the front pillar 17, the gap between the molding 27 and the side door 14 is narrowed to H₂ as shown in FIG. 3. However, even if assembling of the windshield glass 13 with regard to the front pillar 17 is displaced as above, the gap is surely covered by the hollow-shape portion 28d, and a change in this gap is absorbed by elastic deformation of the hollow-shape portion 28d. As a result, the appearance of the front pillar 17 is not impaired when the side door 14 is open. Also, since the hollow-shape portion 28d surely covers the gap between the molding 27 and the front pillar 17 while a seal pressure is kept even, there is generated little force that the hollow-shape portion 28d lifts up the windshield glass 13. As a result, since the windshield glass 13 is not lifted to the front. Therefore, even if the gap is changed, the appearance of the windshield glass 13 is not impaired. Moreover, since the front pillar 17 is covered with the windshield glass 13. Therefore, even if assembling of the windshield glass 13 is displaced in the vehicle width direction with respect to the front pillar 17, the gap between the molding 27 and the front pillar 17 is surely covered by deformation of the hollow-shape portion 28d. As a result, the appearance of both side portions of the windshield glass 13 is not impaired.

What is claimed is:

1. A front structure of a vehicle in which a front pillar (17) is provided between a side portion of a windshield glass (13) and a front portion of a side door (14), a molding (27) is fitted into an outer periphery portion of the windshield glass (13), and the inner surface of the side portion of the windshield glass (13) is bonded to the front pillar (17), wherein
a hollow-shape portion (28d) for contacting the front pillar (17) is provided at the molding (27), and
the hollow-shape portion (28d) is constructed for contacting the front pillar (17) so as to cover a gap between the molding (27) and the front pillar (17).

2. The front structure of a vehicle of claim 1, wherein the front pillar (17) is covered with the windshield glass (13).
